(19) United States
(12) Patent Application Publication
(10) Pub. No.: US 2002/0103629 A1
(43) Pub. Date: Aug. 1, 2002

(54) Model-based method for designing an oscillation damping device and installation having such an oscillation damping device

(76) Inventors: Rudiger Kutzner, Erlangen (DE); Rudiger Reichow, Rottenbach (DE); Kai Schulz, Hemhofen (DE)

Correspondence Address: LERNER AND GREENBERG , P.A., Post Office Box 2480, Hollywood, FL, 33022-2480, US

(21) Appl. No.: 09/741,306

(22) Filed: Dec. 18, 2000

Related U.S. Application Data
(63) Continuation of application No. PCT/DE99/01773, filed on Jun. 16, 1999.

(30) Foreign Application Priority Data
Jun. 17, 1998 (DE) 198 27 021.6

(51) Int. Cl. G05D 17/00

(52) U.S. Cl. 703/7; 703/18

(57) ABSTRACT

A model-based method for designing an oscillation damping device and an installation having such an oscillation damping device are provided. Oscillation damping devices for turbogenerators in gas and/or steam power plants serve the purpose of reducing power oscillations which occur. Such a device can be designed on the basis of a model. A physical linear model is used and a differentiating effect is taken into account when designing for improving a damping response, thus ensuring that an output signal of the oscillation damping device is zero in a steady state.

### CROSS-REFERENCE TO RELATED APPLICATION

This application is a continuation of copending International Application No. PCT/DE99/01773, filed Jun. 16, 1999, which designated the United States.

### BACKGROUND OF THE INVENTION

### FIELD OF THE INVENTION

The invention relates to a model-based method for designing, planning or laying out an oscillation damping device and an installation using the oscillation damping device which is thus provided. The aim is to use such an oscillation damping device for turbogenerators in gas and/or steam power plants to reduce power oscillations which occur, with modulation of excitation usually being derived from a significant signal.

The use of oscillation damping devices in practice is explained, for example, in a publication entitled: Siemens-Energietechnik 3, 1981, Issue 2, pages 50 to 53. Further details regarding this topic are to be gathered from a publication entitled: e&i, Vol. 107, Issue 1, pages 524 to 531.

In practice, oscillation damping devices, so-called PDGs, usually are initially adapted to an installation and optimized. It has also already been proposed to design a PDG with the aid of models.

European Patent Application EP 0 713 287 A1, corresponding to U.S. Pat. No. 5,698,968, discloses an oscillation damping device for generators, in the case of which a so-called observer specifically for acceleration is assigned in each case to a stabilizing circuit. A differentiating effect is thereby achieved with reference to an angle. The design becomes comparatively complicated with a multiplicity of observers.

### SUMMARY OF THE INVENTION

It is accordingly an object of the invention to provide a model-based method for designing an oscillation damping device and an installation having such an oscillation damping device, which overcome the hereinafore-mentioned disadvantages of the heretofore-known methods and installations of this general type and in which the oscillation damping device has an optimized norm and satisfies practical requirements.

With the foregoing and other objects in view there is provided, in accordance with the invention, a model-based method for designing an oscillation-damping device for turbogenerators in gas and/or steam power plants using a physical section model, which comprises taking a differentiating effect into account when designing for improving a damping response of the oscillation-damping device in the section model, to ensure that an output signal of the oscillation-damping device is zero in a steady state.

In accordance with another mode of the invention, the design method further comprises taking the differentiating effect into account for speed and/or power.

In accordance with a further mode of the invention, the design method further comprises prescribing a damping factor directly through a weighting function over all frequencies at once as well as for special frequency ranges with dynamic transfer functions.

With the objects of the invention in view , there is also provided an installation for a gas and/or steam power plant having a turbogenerator with a turbine and a generator. The installation comprises at least one oscillation damping device for reducing power oscillations of the turbogenerator by deriving a modulation of an excitation of the generator from a significant signal. The at least one oscillation damping device is configured to take a differentiating effect into account for improving a damping response of the oscillation-damping device in a physical section model, to ensure that an output signal of the oscillation-damping device is zero in a steady-state.

In accordance with another feature of the invention, the at least one oscillation damping device acts on an excitation of the generator.

In accordance with a further feature of the invention, the at least one oscillation damping device acts on a valve position of a turbine controller.

In accordance with a concomitant feature of the invention, the at least one oscillation damping device includes two oscillation damping devices, one of the oscillation damping devices acts on the excitation of the generator, and the other of the oscillation damping devices acts on a valve position when the turbine is being controlled.

The criterion of the differentiating action, which is essential for oscillation damping devices, is already taken into account as a result of the invention during the model-based design. Observers for special variables are then no longer required in the case of the oscillation damping device. Substantial practical improvements result thereby.

Other features which are considered as characteristic for the invention are set forth in the appended claims.

Although the invention is illustrated and described herein as embodied in a model-based method for designing an oscillation damping device and an installation having such an oscillation damping device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic and block diagram of a control of a turbogenerator set;

FIG. 2 is a block diagram of a conventional oscillation damping device, which is also referred to as a PDG;

FIG. 3 is a block diagram of a linear model for designing an oscillation damping device;

FIG. 4 is a block diagram of a so-called standard problem for a PDG;

FIG. 5 is a block diagram showing a result of a mode of a process according to the invention;

FIG. 6 is a diagram showing a reduction of a solution from FIG. 5 for a system of 3^{rd} or 4^{th} order;

FIG. 7 is a block diagram of a design of a multi-variable PDG; and

FIG. 8 is a schematic and block diagram of a configuration of a gas turbogenerator set controlled by two PDGs.

### DESCRIPTION OF THE PREFERRED EMBODIMENTS

A specific example of the invention will be explained with the aid of the following discussion, while referring in detail to the figures of the drawings. In addition to a specific power PDG, it is also possible to take speed into account in a corresponding way, or it is also possible for a turbine controller or governor to be influenced.

In addition to speed/power control and voltage control, the control of turbogenerator sets in electrical power supply also generally includes an oscillation damping device (PDG) for reducing active power oscillations. Whereas previously the task was generally limited to damping oscillations in large steam turbine sets with respect to a quasi-stiff network, today even relatively small turbogenerator sets are provided with a PDG of which substantially raised requirements are made: the network operator requires verification of the damping action in a widened frequency range. Apart from the classical damping of the natural frequency of the turbogenerator set at approximately 1 Hz, it is also necessary to make a positive contribution to reducing low-frequency oscillations. The background is inter area modes, which are occurring more frequently, not in the least due to the widening of an interconnected network or to the opening of supply networks. Oscillations between individual network nodes are to be understood by such modes. Depending on the distance of the nodes, their frequencies are substantially below 1 Hz and frequently they range from 0.6 Hz to 0.8 Hz.

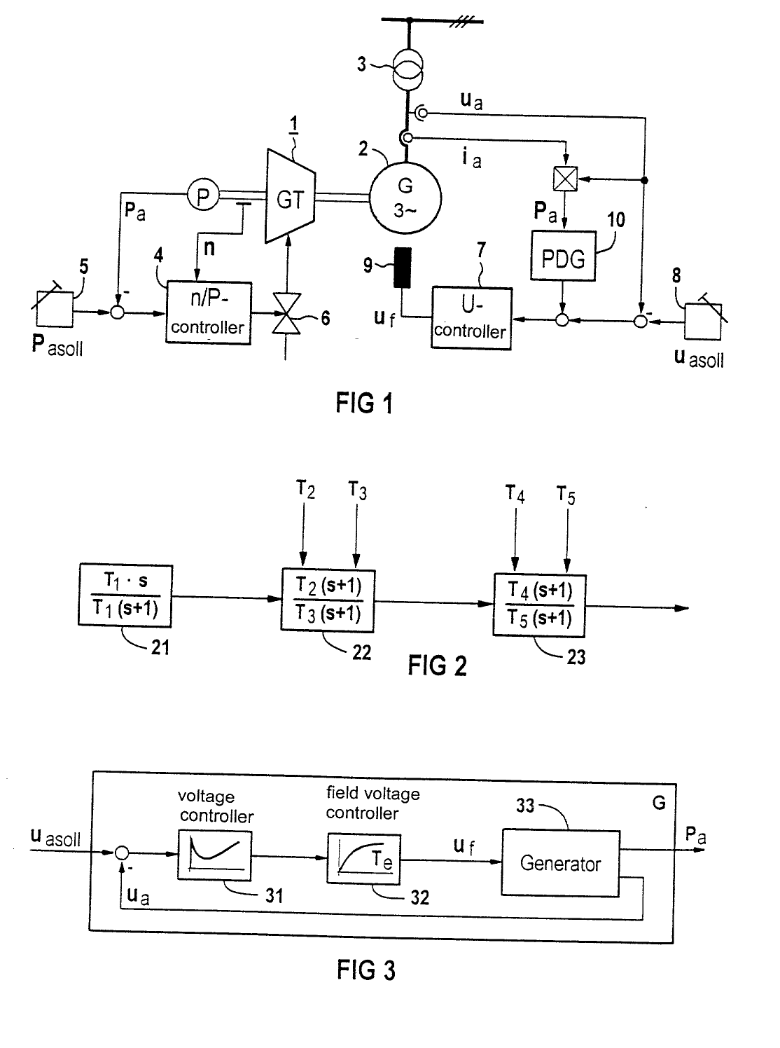

The oscillation response of the turbogenerator set is determined by numerous installation-specific parameters and by its connection to the interconnected network. FIG. 1 provides an overview of the components of the installation. A turbogenerator set for a gas and/or steam power plant includes a turbine 1 and an electric generator 2, which feeds into an electric network 3. A speed/power controller 4 with an actuator 5 for a valve 6 used for feeding the turbine is provided, as is a voltage controller 7 with an actuator 8 for a field voltage at a rotor 9 of the generator 2. The voltage controller 7 is associated with the oscillation damping device 10.

The turbogenerator set is controlled in detail by the turbine controller, which includes a speed controller and a power controller, through the control valves of the turbine, and by the voltage controller through an excitation u_{f} of the generator. An active power pₐ of the generator can be formed from a terminal voltage uₐ and a terminal current iₐ. A speed n of the turbogenerator set is mostly provided by an incremental encoder.

The turbine controller is unsuitable for the function of oscillation damping in the described frequency range due to the limited dynamics of the valves and the turbine. Although the active power can only be influenced by the excitation dynamically, since only the turbine supplies the stationary component, the couplings for an additional control loop can nevertheless be used for oscillation damping.

What is important, therefore, is to use the voltage controller to impress transient torques on the excitation for the purpose of oscillation damping. However, the frequency range of the PDG output signal must be limited toward low frequencies in order to avoid undesired couplings to the voltage control.

FIG. 2 is a simplified illustration of a notation of a known oscillation damping device with units 21 to 23. Parameters Tᵢ (where i=1, 2, 3, 4, 5), which can be set specifically for the specific use of the PDG as a function of a variables in each case, are essential, and is indicated by arrows in FIG. 2.

A block diagram can be developed for the model-based design of a PDG by starting from the preceding explanations. The dynamic properties of the turbine control can be largely neglected in this case, with the result that the model for designing the oscillation damping device includes the excitation system and the generator operated on the network. Speed fluctuations result through a starting time constant from the turbine torque, which is assumed to be constant, and a reaction torque of the synchronous generator.

The behavior of the generator is a nonlinear function of the selected operating point and the network connection. However, the power oscillations which occur do so in the small signal range, with the result that linearization is permissible. The design need only ensure adequate robustness for the operating range of the generator.

FIG. 3 shows the composition of the linearized model. It includes respective units 31 to 33, namely a voltage controller, a field voltage controller and a generator, which feeds its power into the network, as has already been described with the aid of FIG. 1. The parameters of the individual components are known to the manufacturer or operator, with the result that this model can be set up without expensive measurements. In the case under consideration, the static excitation system is approximated by a small equivalent time constant. Since the data vary from installation to installation, the PDG is tuned optimally to the respective turbogenerator set.

The response characteristic in the relevant frequency range from approximately 0.4 Hz to 2.5 Hz is simulated sufficiently accurately by this linear model for small amplitudes. It is therefore possible to set up the following system including the complete voltage control loop.

pₐ=Fₚᵤuₐₛₒₗₗ (1)

A transfer function Fₚᵤ describes a response of the active power to changes in the desired value of the terminal voltage. The control aims mentioned at the beginning can be discussed with the aid of the variation in absolute value of this transfer function

$${F}_{pu} = \frac{P a}{{u}_{asoll}}$$

in the frequency range. An H_{∞} norm of this transfer function corresponds to a maximum gain of this transfer function, and a variation in maximum singular values is identical to a variation in absolute value. The damping can therefore be set directly through the H_{∞} norm or the maximum singular values.

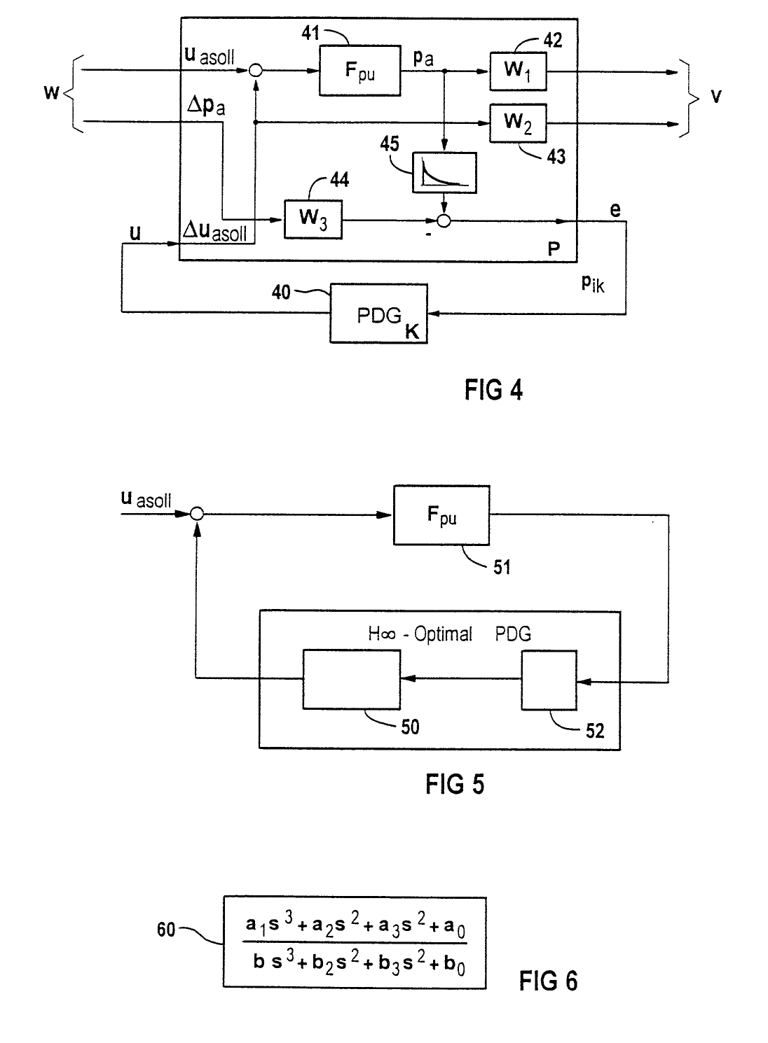

The use of the H_{∞} norm in the case of designing a PDG, as well, is to be undertaken in order to be able to describe the requirements suitably with the aid of this norm. Requirements made on the control, noting that the layout of the PDG is regarded formally as designing a controller, and restrictions with regard to the manipulated variable activity, are formulated through frequency-dependent weighting functions Wij. This is denoted in general as a formulation of a so-called standard problem. The controlled system Fₚᵤ which is explained with regard to FIG. 4, for the PDG, recurs in this case. An output of the PDG Δuₐₛₒₗₗ modulates the desired value of the terminal voltage, that is to say the input of the function Fₚᵤ.

The PDG is intended to react only to the alternating components of the power, whereas a stationary adjustment of the terminal voltage as a function of the output power is not desired.

The concept of the so-called standard problem in FIG. 3 takes this aspect into account through the use of a delayed differentiator (DT₁ element) between the generator power and the input of the PDG, as early as during the planning or design phase. If the DT₁ element is added to the PDG upon completion of the design, this ensures that the step response of the PDG regarded as a “controller” assumes a value 0 as a steady state.

In a strict sense, a PDG is not a controller in the usual sense. Formally, however, this standard problem corresponds to a controller design problem, with the result that this designation is also used herein.

The treatment of the design problem for an oscillation damping device is illustrated with the aid of FIG. 4. In FIG. 4, reference symbol w indicates inputs, and reference symbol v indicates outputs, of the design problem which interact with the overall block. In addition to a unit 41 with the linear model Fₚᵤ a block P also includes units 42 to 44 with weighting functions W₁, W₂, W₃ and a unit 45 with a differentiation element. After a decomposition of P into four individual transfer functions

$$[ \begin{matrix}v \\ e\end{matrix} ] = [ \begin{matrix}{P}_{11} & {P}_{12} \\ {P}_{21} & {P}_{22}\end{matrix} ] [ \begin{matrix}w \\ u\end{matrix} ] \qquad ( 2 )$$

a function T_{vw} is recognized, the norm of which is to be minimized by a “controller” K, the PDG 40.

v=T_{vw}W

T_{vw}=P₁₁+P₁₂K(I−P₂₂K)⁻¹P₂₁,|Tvw|∞ [symbol] minₖ (3)

In this case,

$${T}_{vw} = [ \begin{matrix}{W}_{1} {F}_{pu} & {W}_{1} {F}_{p \overline{p}} {W}_{3} \\ {W}_{2} {F}_{uu} & {W}_{2} {F}_{u \overline{p}} {W}_{3}\end{matrix} ] \qquad ( 4 )$$

contains the transfer functions to be weighted

$$\begin{matrix}{F}_{pu} = \frac{{P}_{a}}{{u}_{asoll}} , {F}_{p \overline{p}} = \frac{{P}_{a}}{Δ {p}_{a}} & ( 5 ) \\ {F}_{uu} = \frac{Δ {u}_{a}}{{u}_{asoll}} , {F}_{u \overline{p}} = \frac{Δ {u}_{asoll}}{Δ {p}_{a}} & ( 6 )\end{matrix}$$

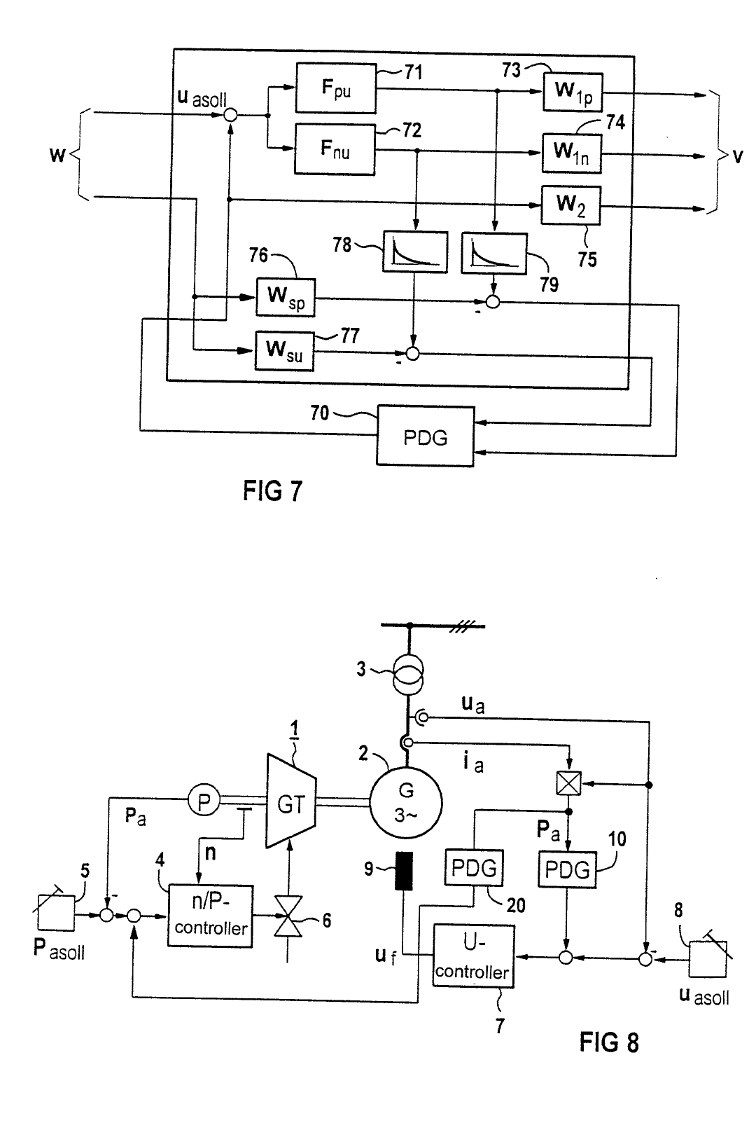

If required, the PDG can be extended by an input, the speed of the turbogenerator set. The standard problem and the model of the generator are to be adapted correspondingly. Reference is furthermore made to FIG. 7 for this purpose.

The variation in absolute value of the transfer function Fₚᵤ determines the assessment of the damping which is achieved. F permits statements regarding the manipulated variable, and thus also the robustness. A second input Δpₐ is used to detect a measured value noise of the power, which exerts a decisive influence on the quality of the control.

The properties of the PDG can be controlled with the aid of the weighting functions. The weighting function W1 influences the damping factor, and the weighting function W2 influences the dynamic use of the “manipulated variable” of the additional desired voltage value Δuₐₛₒₗₗ. The weighting function W3 prescribes the sensitivity to signal noise Δpₐ.

If the “controller” is designed in such a way that

|W₂Fᵤᵤ|≦1 (7)

is fulfilled, the weighting function W₂ can be used to limit the manipulated variable directly, since large values of the weighting function W₂ evidently entail small values for the absolute value of Fᵤᵤ.

A comparison of the converted relationship

$${\vert {W}_{2} \vert}_{∞} \leq \frac{1}{{\vert {F}_{uu} \vert}_{∞}} \qquad ( 8 )$$

with an H_{R} norm of an additive model error Δ_{A}

$$\begin{matrix}G = {G}_{0} + {Δ}_{A} , \\ where & ( 9 ) \\ {\vert {Δ}_{A} \vert}_{∞} < \frac{1}{{\vert {F}_{uu} \vert}_{∞}} & ( 10 )\end{matrix}$$

reveals that a satisfactory statement on the robustness is also made by using the weighting function W₂. The system is likewise stable for all stable Δ_{A} with

|Δ_{A}|_{∞}<|W₂|∞ (11)

This follows adequately from the small gain theorem. The solution to this standard problem is known from the literature found in the prior art.

FIG. 5 illustrates a solution to a design problem of higher order corresponding to a unit 50 together with a unit 51, belonging in this way to the PDG, and of a function of a transfer element 52. The oscillation damping element is a norm optimized one. After the reduction in order of the solution in accordance with the unit 50, a general transfer function of 3^{rd} or 4^{th} order is obtained in accordance with FIG. 6. A block 60 specified therein specifically evaluates functions of 3^{rd} order.

The order of the PDG which is thus determined is derived from the order of the standard problem and thus from the model used as a basis. It is unnecessarily high for practical use, and is therefore reduced with the aid of a method of balanced model reduction to the 3^{rd} to 4^{th} order without a loss of performance. Together with the upstream DT₁ element, this results in a PDG of fourth or fifth order which is integrated directly into the function of a digital voltage controller.

The model of FIG. 4 is expanded in FIG. 7 so as to design a multi-variable PDG 70. Further weighting elements are used for this purpose in order, for example, to also weight the speed and to use it as an input for the PDG. In detail, reference numerals 71, 72 denote units for transfer functions Fₚᵤ and Fₙᵤ, reference numerals 73 to 77 denote weighting elements and reference numerals 78, 79 denote differentiation elements.

Two parameters can therefore be taken into account by the appropriate configuration. This is particularly effective with the described method according to the invention.

It is shown in FIG. 8 that a plurality of oscillation damping devices can be used with a turbogenerator. The open-loop and closed-loop control corresponds largely to the configuration of the turbogenerator set of FIG. 1. In addition to the PDG 10, which acts on the excitation of the generator 2, there can also be a further PDG 20 for controlling the valve position of the turbine 1. The further PDG acts on the control of the valve position of the turbine 1.

The latter PDG 20 also serves to damp the power oscillations. Power oscillations of particularly low frequency, preferably in a range <0.5 Hz, can advantageously be damped thereby. A particularly effective installation is created as a result.

Thus, the design method described herein creates an oscillation damping device which can be used advantageously. Since the problem of oscillation damping has recently acquired new importance, virtually every new power unit is provided with an oscillation damping device (PDG) irrespective of its power.

The network operator can base more stringent requirements on the novel oscillation damping device. In addition to an expanded damping range, this also includes verification of the effect through simulation studies. This requires the parameters of the generator, the voltage control, the excitation system and the network relationships. This information can be used as early as when designing the PDG.

The starting point in the prior art was a fixed structure of the PDG, having parameters which are optimized on site for the respective turbogenerator set. The design method described herein now creates a model-based PDG which is such that its parameters no longer need to be optimized for the installation by hand, since computer-aided adaptation to the situation of the installation has already taken place in the design. This reduces the time consuming and cost intensive commissioning phase. It is easy to meet the customer's requirement for a simulative forecast of the response in the closed control loop. There is no need for additional analytical tools.

A physical linear model was firstly developed for the design of the novel H_{∞} optimum oscillation damping device with a wide damping band. After the linearization at the operating point, the standard problem was formulated for the controller design. Use of the H_{∞} norm is suggested because the damping can be prescribed directly with the aid of this criterion. The desired response can also be prescribed dynamically through the weighting functions. The design moreover takes into account an adequate robustness with respect to load changes of the generator and to other uncertainty factors such as unavoidable model errors or network changes, and noisy measured variables are likewise tolerated.

The structure described above ensures that the voltage is not influenced in the steady state. After a reduction in order, the PDG can be implemented in a function packet of a digital voltage controller.

We claim:

1. In a model-based method for designing an oscillation-damping device for turbogenerators in gas and/or steam power plants using a physical section model, the improvement which comprises:
taking a differentiating effect into account when designing for improving a damping response of the oscillation-damping device in the section model, to ensure that an output signal of the oscillation-damping device is zero in a steady state.

2. The design method according to claim 1, which further comprises taking the differentiating effect into account for power.

3. The design method according to claim 1, which further comprises taking the differentiating effect into account for the speed.

4. The design method according to claim 1, which further comprises taking the differentiating effect into account for power and speed.

5. The design method according to claim 1, which further comprises prescribing a damping factor directly through a weighting function over all frequencies at once as well as for special frequency ranges with dynamic transfer functions.

6. An installation for a gas and/or steam power plant having a turbogenerator with a turbine and a generator, the installation comprising:
at least one oscillation damping device for reducing power oscillations of the turbogenerator by deriving a modulation of an excitation of the generator from a significant signal; and
said at least one oscillation damping device being configured to take a differentiating effect into account for improving a damping response of said at least one oscillation-damping device in a physical section model, to ensure that an output signal of said at least one oscillation-damping device is zero in a steady-state.

7. The installation according to claim 6, wherein said at least one oscillation damping device acts on an excitation of the generator.

8. The installation according to claim 6, wherein said at least one oscillation damping device acts on a valve position of a turbine controller.

9. The installation according to claim 6, wherein said at least one oscillation damping device includes two oscillation damping devices, one of said oscillation damping devices acts on the excitation of the generator, and the other of said oscillation damping devices acts on a valve position when the turbine is being controlled.
